(19) United States
(12) Patent Application Publication
(10) Pub. No.: US 2011/0132674 A1
(43) Pub. Date: Jun. 9, 2011

(54) INTERNAL COMBUSTION ENGINE/HYBRID TRANSMISSION ASSEMBLY

(75) Inventors: Kai Borntrager, Langenargen (DE); Bernard Hunold, Friedrichshafen (DE); Max Bachmann, Waldsee (DE); Rene Budach, Ravensburg (DE)

(73) Assignee: ZF FRIEDRICHSHAFEN AG, Friedrichshafen (DE)

(21) Appl. No.: 13/003,804

(22) PCT Filed: Jul. 16, 2009
(86) PCT No.: PCT/EP2009/059151

§ 371 Date: Jan. 12, 2011

(30) Foreign Application Priority Data
Jul. 17, 2008 (DE) 10 2008 040 489.6

(51) Int. Cl. B60K 6/26

(52) U.S. Cl. 180/65.22; 180/65.21; 903/902

(57) ABSTRACT

An internal combustion engine/hybrid transmission assembly of a motor vehicle, comprising an internal combustion engine and a hybrid module mounted on the internal combustion engine, the internal combustion engine having a flywheel. The hybrid transmission comprises a transmission and a hybrid module. The hybrid module has an electric motor which comprises a stator, on the stator side, and a rotor, on the rotor side, and the stator on the stator side comprises a stator housing, a stator liner which accommodates a stator core, and an end winding positioned on both sides of the stator core, when viewed in the axial direction. The section of the end winding, positioned on the side of the stator core facing the flywheel, is at least partially covered by a section of the flywheel, when viewed in the axial direction.

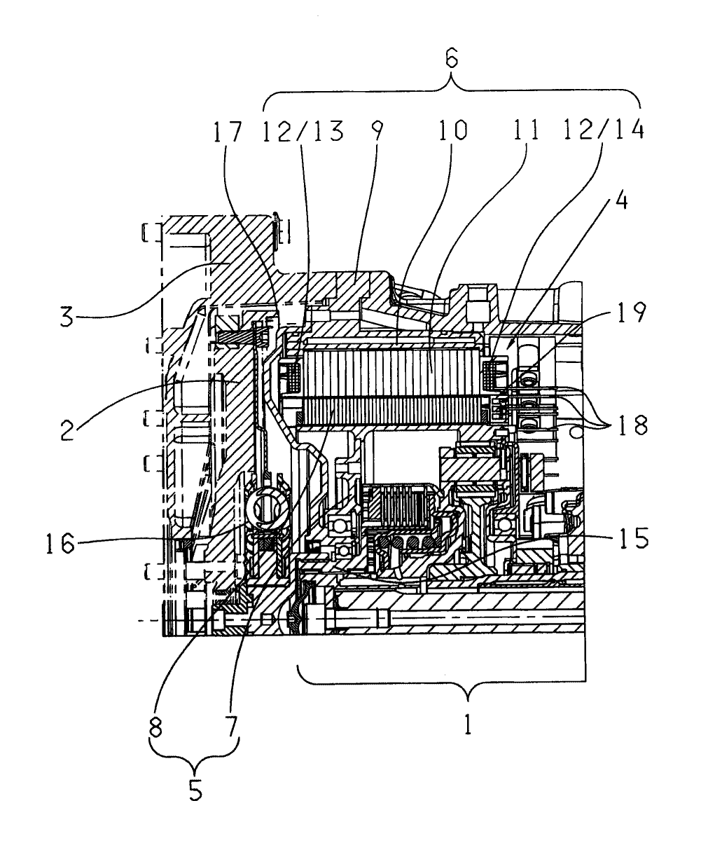

This application is a National Stage completion of PCT/EP2009/059151 filed Jul 16, 2009, which claims priority from German patent application serial no. 10 2008 040 489.6 filed Jul 17, 2008.

### FIELD OF THE INVENTION

The invention relates to an internal combustion engine/hybrid transmission assembly.

### BACKGROUND OF THE INVENTION

The main components of a drive train of a motor vehicle are a drive assembly and a transmission. A transmission converts torques and speeds of rotation and implements the available tractive force of the drive assembly in such a manner that it can be utilized at wheels of the motor vehicle. The invention relates to an internal combustion engine/hybrid transmission assembly, in which case a hybrid transmission is understood to be the unit composed of hybrid module and transmission of a drive train comprising a hybrid drive. A hybrid module comprises an electric motor, among other things. The object of the invention is to locate the electric motor of the hybrid module in the internal combustion engine/hybrid transmission assembly in a manner that saves construction space.

### SUMMARY OF THE INVENTION

Proceeding therefrom, the problem addressed by the present invention is that of creating a new type of internal combustion engine/hybrid transmission assembly. This problem is solved by an inventive internal combustion engine/hybrid transmission assembly. According to the invention, the section of the end winding positioned on the side of the stator core facing the flywheel is covered at least partially by a section of the flywheel as viewed in the axial direction.

The object of the invention is to locate the electric motor of the hybrid module in the internal combustion engine/hybrid transmission assembly in a manner that saves construction space.

### BRIEF DESCRIPTION OF THE DRAWINGS

Preferred developments of the invention will become apparent from the dependent claims and the description that follows. Embodiments of the invention are explained in greater detail with reference to the drawing, without being limited thereto.

The sole FIGURE shows a section of an internal combustion engine/hybrid transmission assembly according to the invention.

### DETAILED DESCRIPTION OF THE PREFERRED EMBODIMENTS

The FIGURE shows a section of an internal combustion engine/hybrid transmission assembly of a motor vehicle according to the invention showing a section of a hybrid module 1 of the hybrid transmission, and a flywheel 2 and a flywheel housing 3 of the internal combustion engine. The hybrid module 1 comprises, among other things, an electric motor 4 having a rotor 5 on the rotor side and a stator 6 on the stator side. A rotor body 7 and a rotor laminated core 8 of the rotor-side rotor 5 of the electric module 4 of the hybrid module 1 are shown. A stator housing 9, a stator liner 10, a stator core 11, and an end winding 12 of the stator-side stator 6 of the electric motor 4 are shown, the end winding 12 comprising two sections 13, 14.

In the embodiment depicted in the Figure, a transmission shaft 15 of the hybrid module 11 of the hybrid transmission is connected to the flywheel 2 of the internal combustion engine by a torsion damper 16.

As already described, the end winding 12 of the electric motor 4 comprises two sections 13, 14, the section 13 being positioned on the side of the stator core 11 facing the flywheel 2, and the section 14 being positioned on the side of the stator core 11 facing away from the flywheel 2. According to the invention, the section 13 of the end winding 12 positioned on the side of the stator core 11 facing the flywheel 2 is covered at least partially by a section 17 of the flywheel 2 of the internal combustion engine as viewed in the axial direction. The section 17 of the flywheel 2 covers the section 13 of the end winding 12 radially outwardly.

The section 17 of the flywheel 2 which covers the section 13 of the end winding 12 at least partially on the side of the stator core 11 facing the flywheel 2 can be a so-called starter ring gear of the internal combustion engine.

Current or voltage is supplied to the end winding 12 of the electric motor 4 via the section 14 positioned on the side of the stator core 11 facing away from the flywheel 2, namely via wires 18 that extend into the section 14 of the end winding 12. A bus bar 19 is used to route all of the wires 18 to the section 14 of the end winding 12.

Given that the section 13 of the end winding 12 positioned on the side of the stator core 11 facing the flywheel 2 is covered at least in partially by the section 17 of the flywheel 2 in the axial direction, axial construction space can be provided by integrating the electric motor 4 in the internal combustion engine/hybrid transmission assembly. As a result, the overall installed length of the internal combustion engine/hybrid transmission assembly in the motor vehicle is made shorter.

### REFERENCE CHARACTERS

1 hybrid module
2 flywheel
3 flywheel housing
4 electric motor
5 rotor
6 stator
7 rotor body
8 rotor laminated core
9 stator housing
10 stator liner
11 stator core
12 end winding
13 section
14 section
15 transmission shaft
16 torsion damper
17 section
18 wire
19 bus bar

1-4. (canceled)

5. An internal combustion engine/hybrid transmission assembly for a motor vehicle, the internal combustion engine/hybrid transmission assembly comprising:
an internal combustion engine; and
a hybrid transmission mounted on the internal combustion engine,
the internal combustion engine comprising a flywheel,
the hybrid transmission assembly comprising a transmission and a hybrid module,
the hybrid module comprising an electric motor and a stator on a stator side and a rotor on a rotor side, and the stator-side stator comprising a stator housing, a stator liner accommodating a stator core, and an end winding positioned on both sides of the stator core, when viewed in an axial direction,
a section (13) of an end winding (12), positioned on a side of the stator core (11) facing the flywheel (2), being at least partially covered by a section (17) of the flywheel (2), when viewed in the axial direction.

6. The internal combustion engine/hybrid transmission assembly according to claim 5, wherein the section (13) of the end winding (12), positioned on the side of the stator core (11) facing the flywheel (2), is at least partially covered radially outwardly by the section (17) of the flywheel (2), when viewed in the axial direction.

7. The internal combustion engine/hybrid transmission assembly according to claim 5, wherein the section (13) of the end winding (12), positioned on the side of the stator core (11) facing the flywheel (2), is at least partially covered radially outwardly by a starter ring gear of the flywheel (2), when viewed in the axial direction.

8. The internal combustion engine/hybrid transmission assembly according to claim 5, wherein the section (14) of the end winding, positioned on the side of the stator core facing away from the flywheel, is in contact with a voltage supply via at least one wire (18).

9. An internal combustion engine/hybrid transmission assembly for a motor vehicle, the internal combustion engine/hybrid transmission assembly comprising:
an internal combustion engine, and
a hybrid transmission being supported by the internal combustion engine,
the internal combustion engine comprising a flywheel (2), and
the hybrid transmission comprising a transmission and a hybrid module (1) comprising an electric motor (4) with a stator (6) and a rotor (5),
the stator (6) comprising a stator housing (9), a stator liner (10), which accommodates a stator core (11), and first and second end windings (12) that are positioned at opposite axial sides of the stator core (11), when viewed in an axial direction;
a section (13) of the first end winding (12) being axially positioned on a side of the stator core (11) facing the flywheel (2) and being at least partially covered radially outwardly by a starter ring gear of the flywheel (2), when viewed in the axial direction; and
a section (14) of the second end winding (12) is axially positioned on a side of the stator core (11) facing away from the flywheel (2) and contacts a voltage supply via at least one wire (18).
